(19) United States
(12) Patent Application Publication
(10) Pub. No.: US 2026/0253929 A1
(43) Pub. Date: Aug. 27, 2026

(54) VEHICLE FUEL CELL WITH AIR SUPPLY SYSTEM HAVING EJECTOR

(71) Applicant: FORD GLOBAL TECHNOLOGIES, LLC, Dearborn, MI (US)

(72) Inventors: Chris Andrew Weinkauf, Roseville, MI (US); Justin Roberto Rizzi, West Bloomfield, MI (US)

(21) Appl. No.: 19/060,048

(22) Filed: Feb. 21, 2025

(51) Int. Cl. H01M 8/04746; B60L 50/72; B60L 58/30; H01M 8/04082; H01M 8/04089; H01M 8/04111; H01M 8/04119; H01M 8/04492; H01M 8/04537; H01M 8/10

(52) U.S. Cl. CPC H01M 8/04761; B60L 50/72; B60L 58/30; H01M 8/04097; H01M 8/04111; H01M 8/04164; H01M 8/04201; H01M 8/04492; H01M 8/04559; H01M 2008/1095; H01M 2250/20

(57) ABSTRACT

A fuel-cell system comprises a fuel-cell stack including a cathode intake port and a cathode exhaust port, and an oxygen-supply system configured to supply oxygen to the cathode intake port. The system includes a primary loop having a compressor and an ejector. The ejector has a first inlet coupled in fluid communication with the compressor, a second inlet, and an outlet coupled in fluid communication with the cathode intake port. A recirculation loop is arranged to supply exhaust gases from the cathode exhaust port to the second inlet of the ejector

### STATEMENT REGARDING FEDERALLY SPONSORED RESEARCH OR DEVELOPMENT

This invention was made with Government support under Contract No. DE-EE0009858 awarded by the Office of Energy Efficiency and Renewable Energy. The Government has certain rights in the invention.

### TECHNICAL FIELD

This disclosure relates to vehicle fuel cells.

### BACKGROUND

The hydrogen fuel cell, and in particular the proton exchange membrane fuel cell (PEMFC), is one potential power source for automobiles and stationary applications. The reaction in a PEMFC involves hydrogen molecules splitting into hydrogen ions and electrons at the anode, while protons re-combine with oxygen and electrons to form water and release heat at the cathode. Typically, a proton exchange membrane is used as a proton conductor in a PEMFC. A catalyst layer containing, for example, platinum and/or a platinum alloy is used to catalyze the electrode reactions. A gas diffusion layer, which may include a microporous layer and a gas diffusion backing layer, is used to transport reactant gases and electrons as well as remove product water and heat.

### SUMMARY

According to an embodiment, a fuel-cell system comprises a fuel-cell stack including a cathode intake port and a cathode exhaust port, and an oxygen-supply system configured to supply oxygen to the cathode intake port. The system includes a primary loop having a compressor and an ejector. The ejector has a first inlet coupled in fluid communication with the compressor, a second inlet, and an outlet coupled in fluid communication with the cathode intake port. A recirculation loop is arranged to supply exhaust gases from the cathode exhaust port to the second inlet of the ejector.

According to another embodiment, a vehicle comprises a fuel-cell stack including a cathode intake port and a cathode exhaust port, and an oxygen-supply system configured to supply oxygen to the cathode intake port. The system includes a primary loop having a compressor and an ejector. The ejector has a primary inlet coupled in fluid communication with the compressor, a secondary inlet, and an outlet coupled in fluid communication with the cathode intake port. A recirculation loop is connected between the cathode exhaust port and the second inlet of the ejector. The recirculation loop further has a valve actuatable to control a proportion of exhaust gages recirculated to the ejector.

According to yet another embodiment, a vehicle comprises a fuel-cell stack and an oxygen-supply system configured to supply oxygen to a cathode of the fuel-cell stack. The system includes a primary loop having a compressor and an ejector, a recirculation loop configured to supply exhaust gases from the cathode to the ejector, and a valve actuatable to control a proportion of the exhaust gases recirculated to the ejector through the recirculation loop. A vehicle processor is programmed to selectively modulate a position of the valve based on a difference between a measured voltage of the fuel-cell stack and a target voltage of the fuel-cell stack.

### BRIEF DESCRIPTION OF THE DRAWINGS

FIG. 1 is a schematic of a fuel cell vehicle.

FIG. 2 is an exploded view of a proton exchange membrane fuel-cell stack.

FIG. 3 is a schematic diagram of a fuel cell.

FIG. 4 is a cross-sectional side view of an ejector used in an air-supply system of the fuel cell.

FIG. 5 is an alternative arrangement of the fuel cell without a recirculation valve.

FIG. 6 is another alternative arrangement of the fuel cell without a recirculation valve and with a humidifier disposed downstream of the ejector.

FIG. 7 is yet another alternative arrangement of the fuel cell without a recirculation valve and with a humidifier disposed upstream of the ejector.

FIG. 8 is a further alternative arrangement of the fuel cell with a recirculation valve and with a humidifier disposed downstream of the ejector.

FIG. 9 is another alternative arrangement of the fuel cell with a recirculation valve and with a humidifier disposed upstream of the ejector.

FIG. 10 is a control diagram of an algorithm for controlling fuel-cell volage with a recirculation valve of the air supply system.

FIG. 11 is a control diagram of an algorithm for controlling intake-air humidity with a recirculation valve of the air supply system.

FIG. 12 is a plot showing valve position, measured fuel-cell voltage, and a target fuel-cell voltage during an example drive time.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations features illustrated provide representative embodiments for typical applications. Various combinations and modifications of the features consistent with the teachings of this disclosure, however, could be desired for particular applications or implementations.

PEMFC are a popular fuel cell choice for automotive vehicles. The PEMFC generally includes a proton exchange membrane (PEM). The anode and the cathode typically include finely divided catalytic particles, usually platinum, supported on carbon particles and mixed with an ionomer. The catalytic mixture is deposited on opposing sides of the membrane. The combination of the anode-catalytic mixture, the cathode-catalytic mixture, and the PEM form a coated catalyst membrane electrode (CCM). In order to facilitate the transport of reactant gases and to remove the excessive water and heat from the catalytic mixture, a gas diffusion layer (GDL), which may include a microporous layer and a carbon-fiber-based gas diffusion backing layer, may be applied on either side of the CCM to form a membrane electrode assembly (MEA). GDLs also provide mechanical support for the soft goods including the PEM and catalytic mixtures.

MEAs are sandwiched between bipolar plates to form unit cells. The bipolar plates typically include an anode side and a cathode side. Anode fuel flow channels are provided on the anode side of the bipolar plates that allow the anode gas to flow to the anode side of the MEA. Cathode oxidant flow channels are provided on the cathode side of the bipolar plates that allow the cathode gas to flow to the cathode side of the MEA. Coolant channels may be disposed between the anode and cathode sides of the bipolar plates to thermally regulate the fuel cell.

Several unit cells are typically combined in a fuel-cell stack to generate the desired power. For example, the stack may include two hundred or more unit cells arranged in series. The fuel-cell stack receives a cathode reacting gas, typically a flow of air forced through the stack by a compressor. Not all the oxygen is consumed by the stack and some of the air is output as a cathode exhaust gas that may include water as a stack byproduct. The fuel-cell stack also receives an anode hydrogen reacting gas that flows into the anode side of the stack.

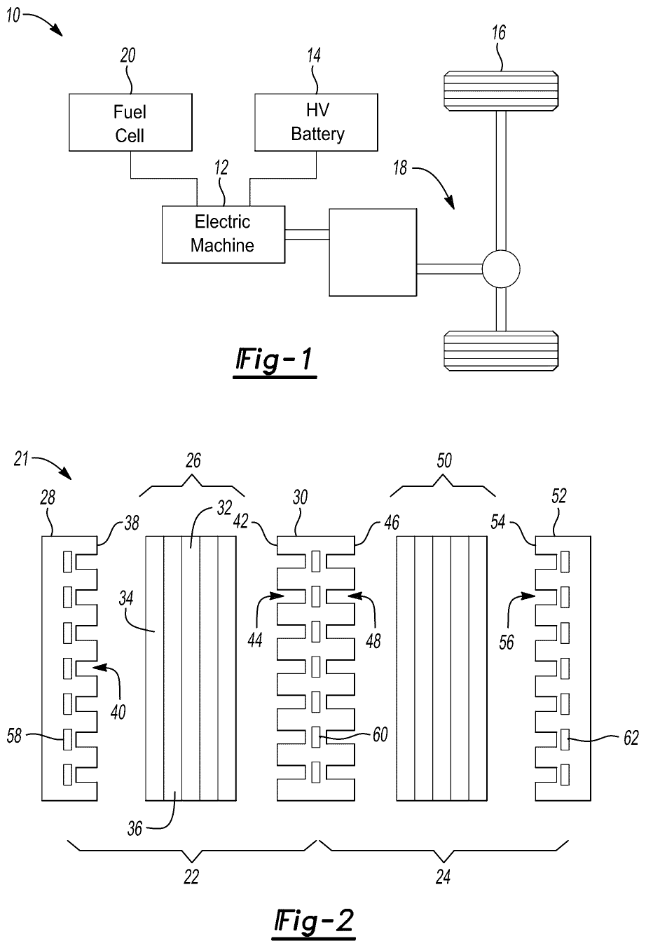

Referring to FIG. 1, a vehicle 10 includes a fuel cell 20 for providing electrical power to at least one electric machine 12. The vehicle 10 may also include a traction battery 14 electrically connected to the fuel cell system 20 and the electric machine 12 by a high-voltage bus. The electric machine 12 is connected to the driven wheels 16 via a drivetrain 18. During operation of the vehicle 10, hydrogen fuel and air are fed into a fuel-cell stack of the fuel cell 20 creating electrical power. The electric machine 12 receives the electrical power as an input, and outputs torque for driving the wheels 16 to propel the vehicle 10.

Referring to FIG. 2, an example fuel-cell stack 21 includes two unit cells 22, 24. The two-cell stack is merely an example and the fuel cell 20 may include dozens or hundreds of stacked unit cells. The first unit cell 22 includes an MEA 26 sandwiched between a first end plate 28 and a bipolar plate 30. The MEA 26 is comprised of a plurality of different layers including a PEM 32, a pair of gas diffusion layers (GDL) 34 and a pair of catalyst layers 36. The endplate 28 includes an anode side 38 defining a plurality of flow paths 40 for the hydrogen fuel. The bipolar plate 30 includes a cathode side 42 defining a plurality of flow paths 44 for air and an anode side 46 defining a plurality of flow paths 48 for hydrogen fuel for the second unit cell 24. A second MEA 50 is sandwiched between the bipolar plate 30 and a last endplate 52. The last endplate 52 includes a cathode side 54 defining a plurality of flow paths 56 for air. The coolant channels 58, 60, 62 are configured to circulate coolant, such as ethylene glycol.

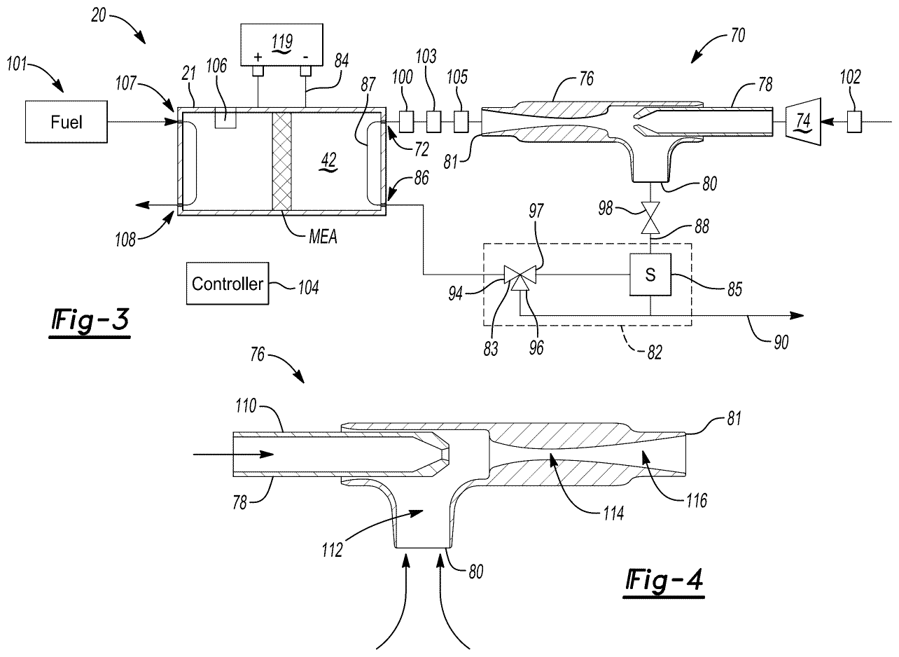

Referring to FIG. 3, the fuel cell 20 includes an oxygen-supply system 70 that delivers ambient air (including oxygen) to the cathode intake port 72 (inlet), which is in fluid communication with the air flow paths 87 of the cathode side 42. The air supply 70 includes an air compressor 74 that draws air from outside of the vehicle. The compressor 74 may be powered by an electric motor or other power source. A particulate and/or chemical filter may be provided to clean the air. An intercooler (optional) may be provided to reduce the temperature of the air exiting the compressor 74. The compressed air then travels to an ejector 76. The ejector 76 includes a primary inlet 78 coupled to the downstream side of the compressor 74, a secondary inlet 80, and an outlet 81. The outlet 81 is coupled to the intake port 72. While not shown, a humidifier may be used to humidify the air either upstream or downstream of the ejector 76 (See, e.g., FIGS. 6-9.)

The fuel-cell stack 21 includes a plurality of the passageways 87 that connect the cathode intake port 72 with the various cathodes channels. The compressed air circulates to through these cathode channels facilitating the chemical reactions across the MEA to produce electricity that is captured by one or more circuits 84 that may connect with a high-voltage bus 119 of the vehicle.

The air (and product water) exits the fuel-cell stack 21 at a cathode exhaust port (outlet) 86. The exhaust gases and water then pass to a cathode exhaust 82. The cathode exhaust 82 may include a throttle valve 83 and a separator 85. The sequence of the valve and the separator is merely exemplary and can be switched and other embodiments. The valve 83 controls the amount of exhaust being routed to a recirculation loop 88 and the tailpipe 90.

The throttle valve 83 also controls the flow rate (mass air flow) and/or pressure of the air through cathode side 42 of the fuel-cell stack 21. The throttle valve 83 may include a body defining an inlet 94 and outlets 96, 97, The inlet 94 receives air from the exhaust port 86, the outlet 96 vents the air to the atmosphere though the tailpipe 90, and the outlet 97 goes to the recirculation loop 88. Within the body is at least one actuatable member, e.g., a flap, a butterfly, a ball, or the like, that is movable to increase and decrease the size of the opening(s) (orifice) through the throttle valve 83, which in tum regulates the mass air flow and/or the pressure through fuel-cell stack 21 and determines the proportion of the flow to each outlet 96, 97. While valve 83 is shown as a three-way valve, two two-way valves may be used instead.

The recirculation loop 88 is configured to supply exhaust gases (still including oxygen) from the cathode exhaust port 86 to the ejector 76 for reintroduction into the fuel-cell stack 21. The recirculation loop 88 may include a recirculation valve 98 that controls the flow of exhaust gases through the recirculation loop 88. The valve 98 may include a body and at least one actuatable member, e.g., a flap, a butterfly, a ball, or the like, that is movable to increase or decrease the size of the opening through the valve. The outlet side of the valve 98 is coupled to the secondary inlet 80 of the ejector 76.

The oxygen supply 70 may include a pressure sensor 100, a mass air flow sensor 102, a humidity sensor 103, and a temperature sensor 105. The shown placements of the sensors are merely exemplary and may differ in other embodiments as is known in the art. The sensors are in electric communication with a controller 104 and each are configured to a output signal (data) thereto indicated of its measurement. The controller 104 is configured to receive the data from the sensors and interpreted it as the measured values.

The fuel-cell 20 also includes a hydrogen supply system 101 that delivers fuel to the anode intake port 107 and receives exhaust from the anode exhaust port 108. At least some of the exhaust may be recirculated into the intake port 107. An example hydrogen-supply system 100 is described in Applicant's U.S. Pat. No. 11,862,827 issued Jan. 2, 2024, which is incorporated by reference herein.

FIG. 3 illustrates a plurality of lines that graphically represent the air flow paths of the fuel and air systems. These flow paths may be formed within conduits, hoses, tubes, pipes, plenums, manifolds, or any other structure capable of defining an airway.

The controller 104, while illustrated as one controller, may be part of a larger control system and may be controlled by various other controllers throughout the vehicle, such as a vehicle system controller (VSC). It should therefore be understood that the controller 104 and one or more other controllers can collectively be referred to as a “controller” that controls various actuators in response to signals from various sensors to control functions such as operating the compressor 74 and the throttle valve 83. The controller 104 includes a processor and associated memory. For example, the controller 104 includes a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the vehicle.

The controller communicates with various vehicle sensors and actuators via an input/output (I/O) interface that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. The controller 104 may communicate signals to and from the fuel cell, the compressor, the throttle valve, and various sensors. Although not explicitly illustrated, those of ordinary skill in the art will recognize various functions or components that may be controlled by the controller 104 within each of the subsystems identified above.

The humidity of the air entering the cathode intake port 72 is controlled during operation of the fuel cell. One way to humidify the air is to employ a humidifier such as a membrane-style humidifier. The above-described oxygen-supply system 70, which includes the ejector 76 and recirculation loop 88, can humidify the air without the use of a humidifier (or may enable the use of a smaller humidifier). The exhaust gases exiting the exhaust port 86 are at or near the saturation limit, i.e., very humid. The recirculation loop 88 can carry this humid air to the ejector 76 where it is mixed with the ambient air thus increasing the humidity of the airstream exiting the ejector 76. The valve 98 can be controlled to increase or decrease the amount of exhaust gases mixing with the ambient air to control the humidity of the airstream to a desired level without the use of a humidifier. Of course, the system may also be used with a humidifier to allow further control of the humidity.

In addition to controlling humidity, the valve 98 may also be used to control the voltage of the fuel-cell stack 21 by increasing or decreasing the concentration of oxygen entering the cathode intake port 72. The exhaust gases have significantly less oxygen than the ambient air. Therefore, increasing the amount of exhaust gases converging with the ambient air at the ejector 76 reduces the oxygen concentration delivered to the fuel-cell stack 21. Similarly, decreasing the amount of exhaust gases converging with the ambient air at the ejector 76 increases the oxygen concentration delivered to the fuel-cell. This allows for oxygen control without actively controlling the compressor 74 and does not require reduction in the amount of flow rate or pressure being delivered to the cathode, which is associated with compressor control.

It is sometimes desirable to reduce the voltage of the fuel-cell. For example, it is desirable to have the ability to suppress voltage at low current density to allow for lower idle power. It may also be desirable to reduce voltage during system start up, shut down, freeze start, and low stoichiometric operation. Another benefit of voltage suppression is it allows for a decrease in compressor power while maintaining high humidity within the fuel-cell stack.

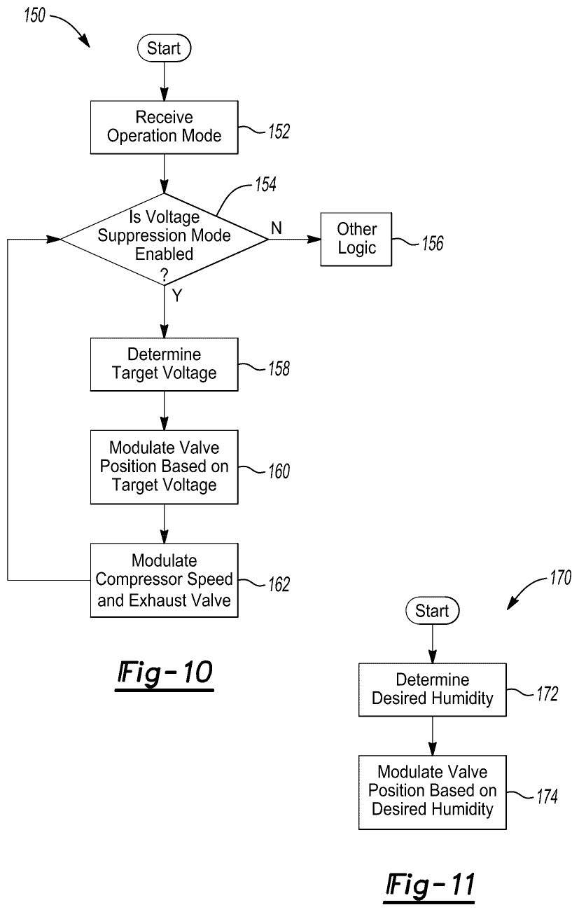

The voltage of a given fuel cell is a function of oxygen concentration and mass air flow. Therefore, all else being constant, reducing the oxygen concentration reduces the fuel-cell voltage. As such, the voltage of the fuel cell can be increased or decreased by changing the amount of recirculated exhaust gases via the valve 98. For example, the opening of the valve 98 can be increased to reduce the voltage, or the opening of the valve 98 can be decreased to increase the voltage. This will be described in more detail below with reference to FIG. 10.

FIG. 4 illustrates an example embodiment of the ejector 76. A gas ejector, also known as a venturi pump, is a passive device that utilizes Bernoulli's principle to pull flow from a secondary gas stream (here the recirculation loop). This is achieved through specific design of the ejector geometry such that the primary gas stream flow results in suction on the secondary gas flow. The ejector 76 includes four main components: a nozzle 110, a suction chamber 112, a mixing chamber 114, and a diffuser 116. The primary inlet 78 is located at the outer end of the nozzle 110, the secondary inlet 80 opens into the suction chamber 112, and the outlet 81 is located at the end of the diffuser 116. During operation, the high flow rate and pressure produced by the compressor flows through the nozzle 110 creating suction in the suction chamber 112, which draws the recirculated exhaust gases into the ejector. The two gas streams combine in the mixing chamber 114 and are discharged through the diffuser 116 to the outlet 81.

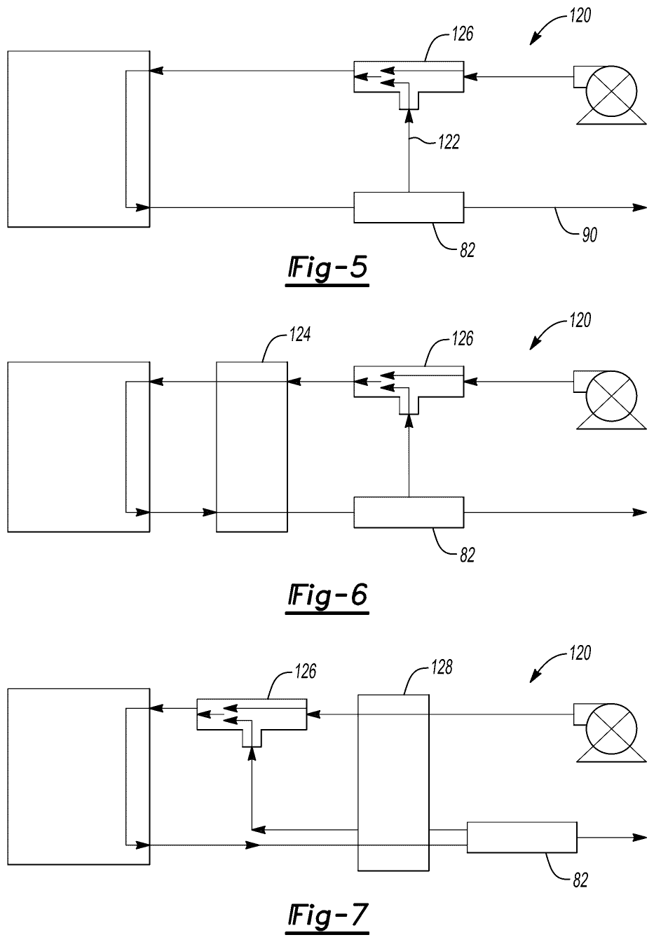

FIGS. 5-9 illustrate alternative configurations of the fuel cell oxygen-supply system described above with reference to FIG. 3. For brevity, common components will not be described in detail again.

Referring to FIG. 5, an oxygen-supply system 120 is similar to the system 70 except the recirculation loop 122 does not include a valve. In this embodiment, the amount of recirculation is not actively controlled. Instead, the ejector 126 is designed to provide a desired ratio of recirculation.

The oxygen-supply system 120 may or may not include a humidifier. FIG. 6 illustrates an example in which a humidifier 124 is included downstream of the ejector 126. FIG. 7 illustrates an example in which the humidifier 128 is placed upstream of the ejector 126.

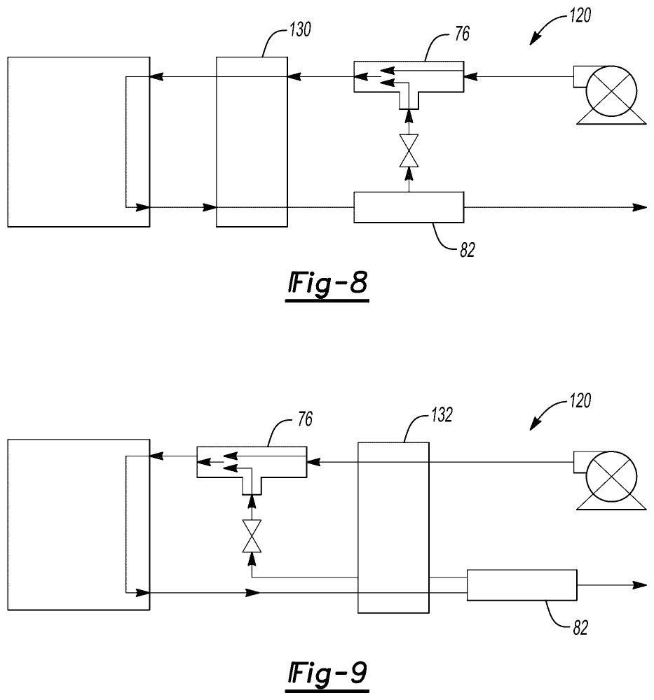

FIGS. 8 and 9 illustrate the oxygen-supply system 70 with an optional humidifier Figure 8 illustrates the humidifier 130 downstream of the ejector 76, whereas FIG. 9 illustrates the humidifier 132 upstream of the ejector 76.

Control logic or functions performed by controller 104 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based vehicle, engine, and/or powertrain controller, such as controller 104. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information. operating variables, and the like.

FIG. 10 illustrates control logic 150 for operating the fuel-cell during a voltage-suppression mode. Control begins at operation 152, where the controller receives the current operating mode of the fuel cell. Example operating modes include normal, startup, shutdown, cold start, and voltage-suppression mode. An operation 154, the controller determines if the voltage-suppression mode is enabled If no, other logic is used. If yes, control passes to operation 158 where the controller determines a target voltage for the fuel-cell stack. The target voltage may be based on a plurality of factors and calibrations that are predetermined and saved in one or more look up tables.

Once the target voltage is determined, the controller modulates the position of the recirculation valve (e.g., valve 98) based on the target voltage at operation 160. As previously discussed, opening the valve 98 reduces the voltage of the fuel-cell stack and closing the valve 98 increases the voltage of the fuel-cell stack. P, PI, or PID control may be used to modulate the valve position. For example, the controller may modulate the opening of the valve to reduce an error between the target voltage and a measured voltage of the fuel-cell stack. The measured voltage may be determined by a voltage sensor 106 (see FIG. 3). Alternatively, one or more look up tables may be used to set the opening of the recirculation valve based on the target voltage. At operation 162, the controller modulates the compressor speed and the cathode exhaust valve based on a desired pressure and temperature of the incoming airstream.

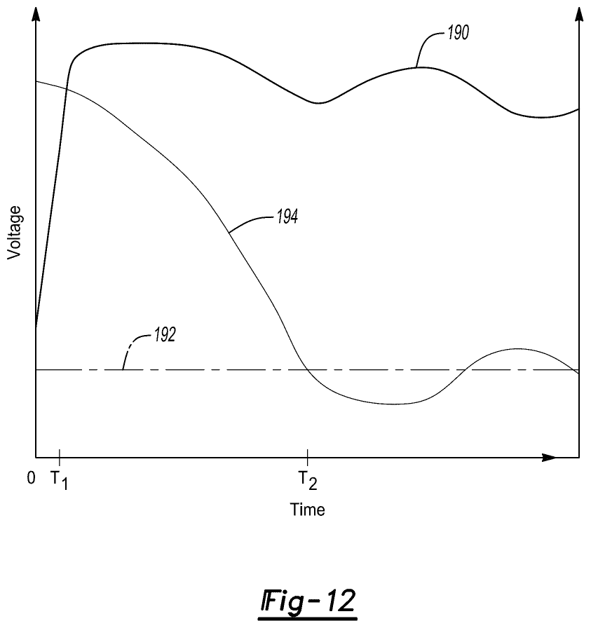

FIG. 11 illustrates control logic 170 for controlling the humidity of the airstream using recirculated cathode exhaust. As discussed above, the cathode exhaust is near saturation point and thus can be used to humidifier the ambient air in lieu of, or in addition to, a humidifier An operation 172, the controller determines a desired humidity for the incoming airstream. At operation 174, the opening of the recirculation valve (e.g., valve 98) is increased or decreased based on the desired humidity. The valve position may be determined using look up tables, or alternatively using closed-loop controls such as P, PI, or PID controls. For example, the valve 98 may be modulated to reduce an error between a target humidity and a measured humidity.

FIG. 12 illustrates valve opening 190 of the recirculation valve (double-dashed line) as a percentage of open (i.e., zero is fully closed), a target voltage 192 of the fuel cell (dashed line), and measured voltage 194 of the fuel cell (solid line). At time zero, the voltage-suppression mode is commenced. As such, a low target voltage is commanded. Prior to T0, the fuel cell voltage was high to provide power for propelling the vehicle. In order to quickly reduce the voltage, a relatively large of amount of low-oxygen exhaust gases are circulated to the ejector by opening the recirculation valve. This is shown by the large spike in valve opening between T0 and T1. (The valve may or may not be fully opened.) The valve remains quite open while the measured voltage plunges toward the low target voltage associated with voltage-suppression mode. At T2, the measured voltage 194 overshoots the target voltage. This results in opening of the valve to increase the fuel cell voltage. After T2, closed loop controls of the valve increase and decrease the opening to reduce the error between the target and measured voltage. This is shown by the undulations of valve opening 190 and measure voltage 194. (Note, the undulations are exaggerated for illustrative purposes.)

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A fuel-cell system comprising:
a fuel-cell stack including a cathode intake port and a cathode exhaust port; and
an oxygen-supply system configured to supply oxygen to the cathode intake port, the system including:
a primary loop having a compressor and an ejector, wherein the ejector has a first inlet coupled in fluid communication with the compressor, a second inlet, and an outlet coupled in fluid communication with the cathode intake port, and
a recirculation loop arranged to supply exhaust gases from the cathode exhaust port to the second inlet of the ejector.

2. The fuel-cell system of claim 1, wherein the ejector includes a nozzle, a suction chamber, a mixing chamber, and a diffuser.

3. The fuel-cell system of claim 2, wherein the first inlet is associated with the nozzle and the second inlet is associated with the suction chamber.

4. The fuel-cell system of claim 2, wherein the recirculation loop has a valve actuatable to control a proportion of the exhaust gases routed to the ejector.

5. The fuel-cell system of claim 1, wherein the outlet of the ejector is directly connected to the intake port by a conduit.

6. The fuel-cell system of claim 1, wherein the primary loop does not include a humidifier.

7. The fuel-cell system of claim 1, wherein the recirculation loop further has a water-air separator disposed between the cathode exhaust port and the valve.

8. The fuel-cell system of claim 1, wherein the recirculation loop has a valve actuatable to control a proportion of the exhaust gases routed to the ejector.

9. The fuel-cell system of claim 8 further comprising:
a humidity sensor configured to output a signal indicative of a humidity of a cathode side of the fuel cell; and
a processor programmed to actuate the valve based on at least the signal output by the humidity sensor.

10. The fuel-cell system of claim 8 further comprising a processor programmed to actuate the valve based on a voltage of the fuel-cell stack.

11. The fuel-cell system of claim 8 further comprising a processor programmed to selectively modulate a position of the valve based on a difference between a measured voltage of the fuel-cell stack and a target voltage of the fuel-cell stack.

12. A vehicle comprising:
a fuel-cell stack including a cathode intake port and a cathode exhaust port; and
an oxygen-supply system configured to supply oxygen to the cathode intake port, the system including:
a primary loop having a compressor and an ejector, wherein the ejector has a primary inlet coupled in fluid communication with the compressor, a secondary inlet, and an outlet coupled in fluid communication with the cathode intake port, and
a recirculation loop connected between the cathode exhaust port and the second inlet of the ejector, wherein the recirculation loop has a valve actuatable to control a proportion of exhaust gages recirculated to the ejector.

13. The vehicle of claim 12, wherein the ejector includes a nozzle that receives air from the primary inlet and a suction chamber that receives exhaust gases from the secondary inlet.

14. The vehicle of claim 12 further comprising a processor programmed to actuate the valve based on a voltage of the fuel-cell stack.

15. The vehicle of claim 12 further comprising a processor programmed to, in response to a voltage suppression mode being enabled, increase an opening of the valve such that a measured voltage of the fuel-cell stack decreases.

16. The vehicle of claim 12 further comprising:
a humidity sensor; and
a processor programmed to actuate the valve based on a signal output by the humidity sensor.

17. A vehicle comprising:
a fuel-cell stack;
an oxygen-supply system configured to supply oxygen to a cathode of the fuel-cell stack, the system including a primary loop having a compressor and an ejector, a recirculation loop configured to supply exhaust gases from the cathode to the ejector, and a valve actuatable to control a proportion of the exhaust gases recirculated to the ejector through the recirculation loop; and
a processor programmed to selectively modulate a position of the valve based on a difference between a measured voltage of the fuel-cell stack and a target voltage of the fuel-cell stack.

18. The vehicle of claim 17, wherein the fuel-cell stack includes an associated voltage sensor configured to output a signal to the processor indicative of the measured voltage.

19. The vehicle of claim 17 further comprising a humidity sensor, wherein the processor is further programmed to modulate the position of the valve based on a signal output by the humidity sensor.

20. The vehicle of claim 17, wherein the ejector includes a nozzle coupled to the primary loop, a suction chamber coupled to the recirculation loop, a mixing chamber, and a diffuser.
